(19) United States
(12) Patent Application Publication
(10) Pub. No.: US 2010/0181415 A1
(43) Pub. Date: Jul. 22, 2010

(54) ROTOR BLADE FOR A ROTARY WING AIRCRAFT

(75) Inventors: Andree Altmikus, Hohenkirchen-Siegertsbrunn (DE); Markus Bauer, Munchen (DE); Boris Grohmann, Taufkirchen (DE); Stephan Mangelsdorf, Munchen (DE); Christoph Maucher, Munchen (DE); Rupert Pfaller, Riemerling (DE); Elif Ahci, Munchen (DE)

Correspondence Address: YOUNG & THOMPSON, 209 Madison Street, Suite 500, Alexandria, VA, 22314, US

(73) Assignees: EUROCOPTER DEUTSCHLAND GMBH, Donauworth (DE); EADS DEUTSCHLAND GMBH, Ottobrunn (DE)

(21) Appl. No.: 12/666,421

(22) PCT Filed: Jun. 5, 2008
(86) PCT No.: PCT/DE08/00934

§ 371 Date: Mar. 5, 2010

(30) Foreign Application Priority Data
Jun. 28, 2007 (DE) 10 2007 030 095.8

(51) Int. Cl. B64C 27/00; B64C 11/04

(52) U.S. Cl. 244/17.11; 416/204 R

(57) ABSTRACT

The invention relates to a rotor blade (20), especially for a rotary wing aircraft. The invention is characterized in that an aerodynamically effective rotor blade profile with a profile nose region (21), a profile base body (20a) with a profile core, an upper and lower cover skin (30) that envelops the profile core (22), and a profile rear edge region (23) with a rear edge (40) and a reversibly bendable supporting member (26) that can be attached with the first end to the end region of the profile base body (20a) pointing toward the rear edge (40) and projects with the second end freely out of the profile base body (20a) and its end region toward the rear edge (40) and forms a movable rotor blade flap (24), and several actuators (35) that are dynamically connected to the projecting second end of the reversibly bendable supporting member (26) and an arc-shaped flap deflection can be initiated via the change in length of the actuators, the second end of the reversibly bendable supporting member (26) that forms the rotor blade flap (24) viewed in the direction of the span (S) being divided by notches (34) into several segments to which at least one actuator (35) at a time is assigned.

### TECHNICAL DOMAIN

This invention relates to a rotor blade with a movable rotor blade flap, especially for a rotary wing aircraft, such as for example a helicopter, and a rotary wing aircraft with such a rotor blade.

### PRIOR ART

Air vortices form in operation on the rotor blades of a rotary wing aircraft. They generate noise and vibrations that can be perceived, for example, in the cabin of the rotary wing aircraft and thus adversely affect the comfort of the passengers. Moreover, these vibrations are disadvantageous with respect to service life and maintenance, since they can lead to material fatigue of components and continued relative motion of the components with the accompanying wear and tear.

Complex aeromechanical and aeroelastic phenomena, for example the collision of a rotor blade with blade vortices of one leading rotor blade at a time and the resulting forces acting on the rotor blade, are the cause of this noise and these vibrations. In order to take into account as much as possible different flight states and varying angles of incidence, rotor blades are used in which the shape of the rotor blade in the region of the rear edge can be changed. By controlled adaptation of the shape of the rotor blade in the region of the rear edge, noise and vibrations can be reduced and at the same time the flight performance and flight envelope can be improved.

In the prior art, rotor blade flaps on the rear edge of the rotor blade are known; they are movably attached, for example, to a rotor blade profile body using a rocker bearing. DE 101 16 479 A1 discloses such a rotor blade, and the rotor blade flap can be triggered via a piezoactuator that—spaced in the direction of the profile depth away from the flap—is located in a front profile region of a rotor blade profile body. The piezoactuator generates positioning forces and transmits them to the rotor blade flap via strip-shaped or rod-shaped tension elements.

This type of rotor blade is exposed to intensified wear due to the articulations. Short operating times until replacement or reduced efficiency are the result. Therefore, DE 103 34 267 A1 proposes a rotor blade with an elastically movable rotor blade flap in which piezoelectric actuators are attached in the rigid cover skins of the wing profile or directly under the cover skins that are inherently rigid or on the rigid cover skins. Thus, alternately, one of the two piezoelectric actuators can be actuated on the top-side cover skin or the bottom-side cover skin of the wing profile. This leads to a displacement of the respective cover skin relative to the other cover skin, by which the upper cover skin is shortened or lengthened relative to the lower cover skin. Due to the relative shortening of one cover skin to the other, the rigid rotor blade flap that is attached to the cover skins is deflected and moved up or down.

JP 8-216-997 discloses a rotor blade for a helicopter in which the cover skin in the vicinity of the rear edge of the rotor blade can expand and contract at least in the direction of the profile chord using a piezoelectric element.

A similar arrangement is also disclosed in DE 103 04 530 A1, the piezoelectric actuators being integrated either into the profile for which there is no flap, or alternatively being provided solely in the flap. For the piezoactuators provided in the flap, the profile flap is deformed by means of the piezoelectric actuators.

As dictated by the system, in these designs with an elastically movable rotor blade flap, the actuator or actuators must be located near the rear edge of the profile, filtered off by suction-section. Since in this region of the blade—due to the pivoting moments and centrifugal force—high tensile strains occur and the actuators are generally sensitive to tension, the elongation due to centrifugal force that occurs can lead to failure of the actuators when the rotor is started.

### DESCRIPTION OF THE INVENTION

On this basis, the object of the invention is to provide a rotor blade with a rotor blade flap that has a mechanically and kinematically simple structure, has favorable aerodynamic properties, enables continuously gradual deformation in the profile chord and span direction, and has reduced elongation of centrifugal force on the actuators.

This object is achieved by the features of claim 1.

The dependent claims form advantageous developments of the invention.

The rotor blade according to the invention, especially for a rotary wing aircraft, comprises an aerodynamically effective rotor blade profile with a profile nose region, a profile base body with a profile core, and an upper and lower cover skin that envelops the profile core, as well as a profile rear edge region with a rear edge. A reversibly bendable supporting member is attached with the first end to an end region of the profile base body pointing toward the rear edge and projects with a second end freely out of the profile base body and its end region beyond the rear edge and forms a movable rotor blade flap. The projecting second end of the reversibly bendable supporting member is dynamically connected to several actuators so that an arc-shaped flap deflection can be initiated via the change in length of the actuators. Here, the second end of the reversibly bendable supporting member that forms the rotor blade flap viewed in the direction of the span (S) is divided by notches into several segments to which at least one actuator at a time is assigned.

The reversibly bendable supporting member with its first end being attached to the end region of the profile base body pointing toward the rear edge results in that additional mechanical elements for attachment of a flap, such as, for example, hinges, are unnecessary. This attachment that lies in the profile structure, moreover, enables stable attachment that is mechanically relatively simple to implement. Since by means of the actuators the entire rotor blade flap, optionally including a filler layer that lies between the cover skin and the supporting member, is deformed, abrupt transitions do not develop, but rather in all deflection states of the flap, uniform, continuous contours arise that can vary both in the profile chord direction and also in the span direction or also only in one of the two directions, when different regions are activated. Dividing the reversibly bendable supporting member and the rotor blade flap into segments advantageously results in that only part of the elongation of centrifugal force and of pivoting on the main rotor blade is transferred into the active rear edge and thus into the actuators. It follows that the actuators “see” only part of the rear edge elongation. The elongation of the actuators can be set over the width of the individual segments, the depth of the notch, and the stiffnesses of the parts that adjoin one another.

According to one embodiment of the invention, the notches are located perpendicular to the span direction (S).

According to one especially advantageous embodiment of the invention, the notches are made obliquely to the span direction (S). This has the effect that using the interrupted, span-wide flow of force in the region of the notches, the loads or stresses are advantageously superimposed by centrifugal force, striking, pivoting, etc., such that in the piezoelement, unwanted stress states, especially tension, do not act or unwanted stress states are reduced. The actuator elements can be additionally pretensioned in compression in this way. Furthermore, the unfavorable, span-wide bending loads in the actuator and the danger of buckling by centrifugal force are reduced.

Preferably, the actuators are applied directly to the reversibly bendable supporting member, for example by means of a bonded or non-positive connection.

According to one preferred embodiment, the actuators are made as piezoactuators, for example with a d33 piezoelement, a d31 piezoelement or else another element that changes shape and that can be activated by supplying electrical current, such as, for example, piezopolymers or piezoceramics in forms other than stacks.

Here, the reversibly bendable supporting member and/or the piezoactuators can have a varying thickness or activation and deformation properties that are matched to the load or the force to be generated; this imparts further flexibility with respect to activation possibilities and deformation of the rotor blade. In particular, the structure of the supporting member and of the piezoactuator can be such that, for example, maximum deflection of the flap or the aerodynamic effectiveness of the flap and of the rotor blade profile is optimized. This optimization can also be intensified in that the supporting member and the piezoactuator are oriented in a controlled manner with respect to material properties when they are dependent on direction as anisotropic materials.

In particular, fiber-reinforced plastic, if necessary with anisotropic or isotropic properties, for example with a matrix of a duromer resin (for example epoxy resin) or a thermoplastic resin and fibers, for example of glass, carbon, aramid or polyamide, are possible as the reversibly bendable supporting member.

Preferably viewed in the direction of lift (A), there is one actuator on both sides of the segment.

It is also conceivable, however, that viewed in the lift direction (A), there is an actuator only on one side of the segments.

Preferably, the supporting member is equipped, for example, as a spring element or is pretensioned, and thus forms a resetting means for the actuators.

More preferably, a flexible filler material is applied to the supporting member; the outside of the material in this region of the rotor blade profile forms its outer contour. The flexible filler material can completely or else only partially cover the supporting member. The flexible or rubber-elastic filler material can form a flexible protective skin according to one preferred embodiment. Alternatively, an additional flexible, bending-elastic protective layer can surround the flexible filler material as an outside termination so that the flexible filler material lies between the supporting member and the protective skin. The protective skin in this case can be, for example, a flexible film, a material that has been subsequently vulcanized, a protective paint or the like. It is also conceivable for the protective layer to be made as an ordinary cover skin, which is generally produced from fiber composite material, and then in the cover skin in the region of the bendable flap region, a local thin site that forms a so-called virtual joint must be present in the cover skin, or the cover skin in the rear edge region of the profile must be made altogether much thinner than usual so that it can be easily deformed when forces are applied by the actuator. One deformable site can be formed, for example, also by a local, flexurally soft insert and/or one that is soft in tension/compression in the cover skin or by a likewise integrated material.

Both the filler material and also the protective skin can be provided on one side or both sides on the supporting member. The use of filler material offers an especially uniform transition between the rotor blade profile and the rotor blade flap with respect to the contour, since the filler material can be contoured as desired. In particular, the filler material can extend as far as the profile base body or its cover layer and/or underneath, therefore between the core and cover layer, and encompass in cross-section, for example in the manner of a fork or tongs, the profile base body in its end region. The profile base body can run, for example, to a point in the filler material over a freely selectable length.

Alternatively thereto, the supporting member without further filler material forms the flap, in this case only the anchoring region of the supporting member lying on or in the rear edge region of the profile. In the region of the rotor blade flap then, there are no other flexible layers, besides optionally a flexurally elastic protective skin directly bordering the supporting member.

For the flexible filler material, preferably a foam material, an elastomer material (for example, silicone), is used as a homogeneous flexible material that follows the deformation of the supporting member and thus leads to flap deflection and a deformation of the flap that corresponds to the deflection and deformation of the supporting member. Alternatively, the filler material can be formed by a supporting framework-like material, i.e., a nonhomogeneous material or a structure. These, for example, rib-like stiffening elements preferably extend, viewed in the direction of the profile thickness, in the cross-section of the rotor blade profile.

To form an interface between the profile base body and rotor blade flap, there is preferably a fastening means for the rotor blade flap such that the rotor blade flap can be detached, for example, for replacement or for maintenance or for testing. This interface contains both a mechanical interface that ensures that the mechanical properties of the original rotor blade are preserved, when the rotor blade and the rotor blade flap are separated and then joined again, and also an electrical interface with electrical connections that due to the mutually matching elements on both components ensures that the, for example, electrical contact-making that preferably takes place via the interior of the profile core can be easily re-established. Since the interface when the flap is attached is not exposed to the environment, it is protected against ambient effects, such as dirt, during operation. Instead of providing an interface with a possibility for detaching the supporting member from the profile base body, the supporting member can also be fastened to the profile without the possibility of detachment.

Other advantages, features, and possible applications of this invention will become apparent from the following description in conjunction with the embodiments shown in the drawings.

The invention is described in more detail below using the embodiment shown in the drawings.

In the description, in the claims, in the abstract and in the drawings, the terms and assigned reference numbers used in the list of reference numbers cited below are used. In the drawings,

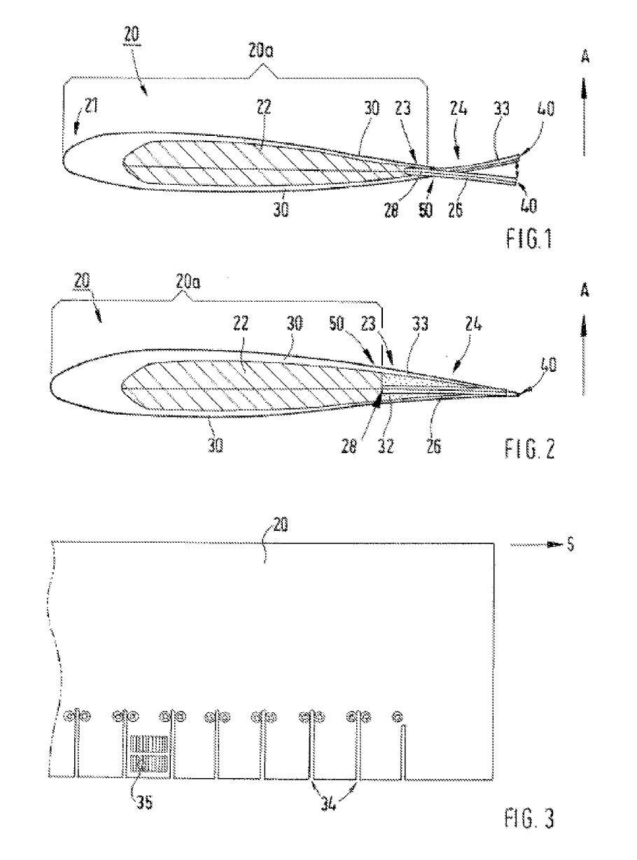

FIG. 1 shows a cross-sectional view through a rotor blade according to a first embodiment of the invention;

FIG. 2 shows a cross-sectional view through a rotor blade according to another embodiment of the invention;

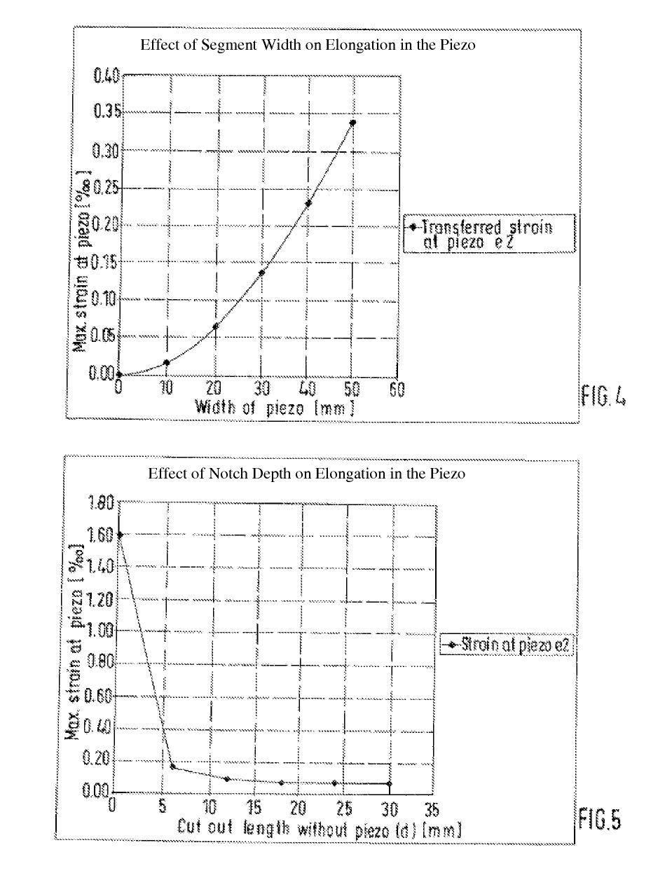

FIG. 3 shows a top view of a rotor blade according to the invention for a rotary wing aircraft with segmented, active rear edge;

FIG. 4 shows a diagram for representation of the effect of the segment width on the elongation of the actuator;

FIG. 5 shows a diagram for representation of the effect of the notch depth per segment on the elongation of the actuator;

FIG. 6 shows another embodiment of the invention with segments that have been set obliquely;

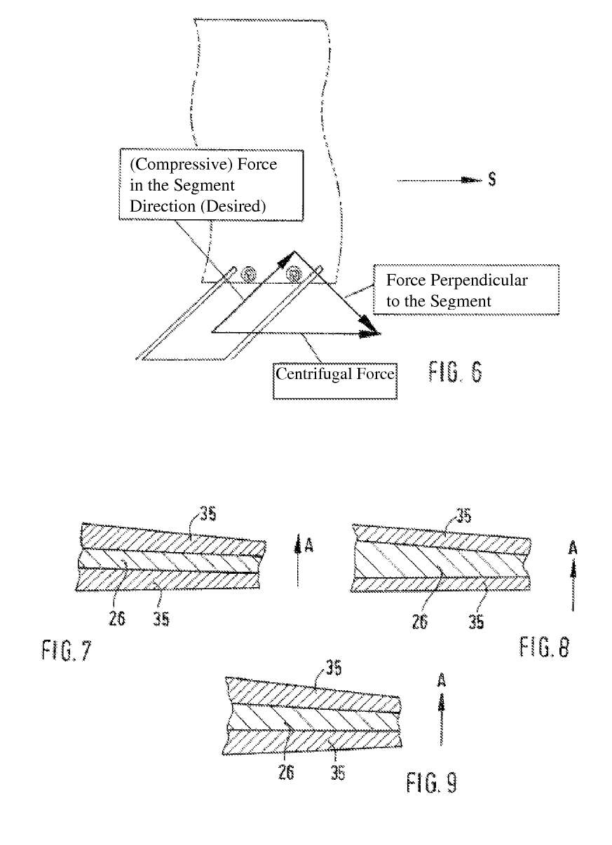

FIG. 7 shows in an enlarged view an extract of the supporting member of the rotor blade according to the invention, which member is dynamically connected to the actuators, in a cross-sectional view;

FIG. 8 shows one alternative embodiment to FIG. 7;

FIG. 9 shows another alternative embodiment to FIG. 7;

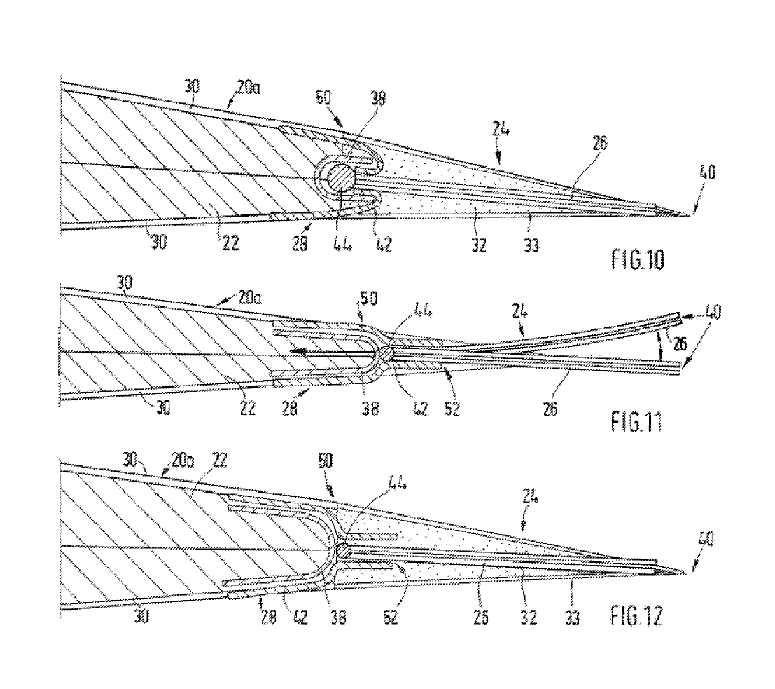

FIG. 10 shows in an enlarged view the rear edge region of a rotor blade profile of the rotor blade according to the invention that has an electrical and a mechanical interface;

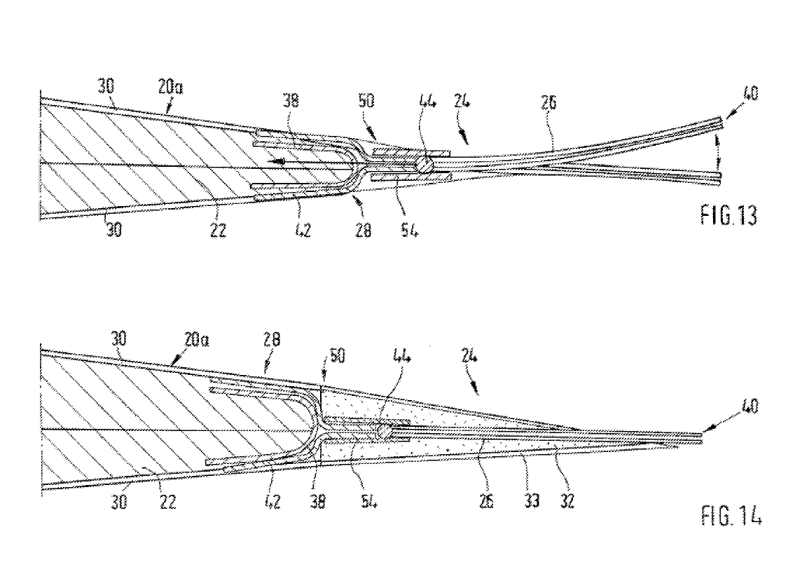

FIG. 11 shows one alternative to the electrical and mechanical interface from FIG. 10;

FIG. 12 shows another alternative to the electrical and mechanical interface from FIG. 10;

FIG. 13 shows a further alternative to the electrical and mechanical interface from FIG. 10;

FIG. 14 shows another alternative to the electrical and mechanical interface from FIG. 10;

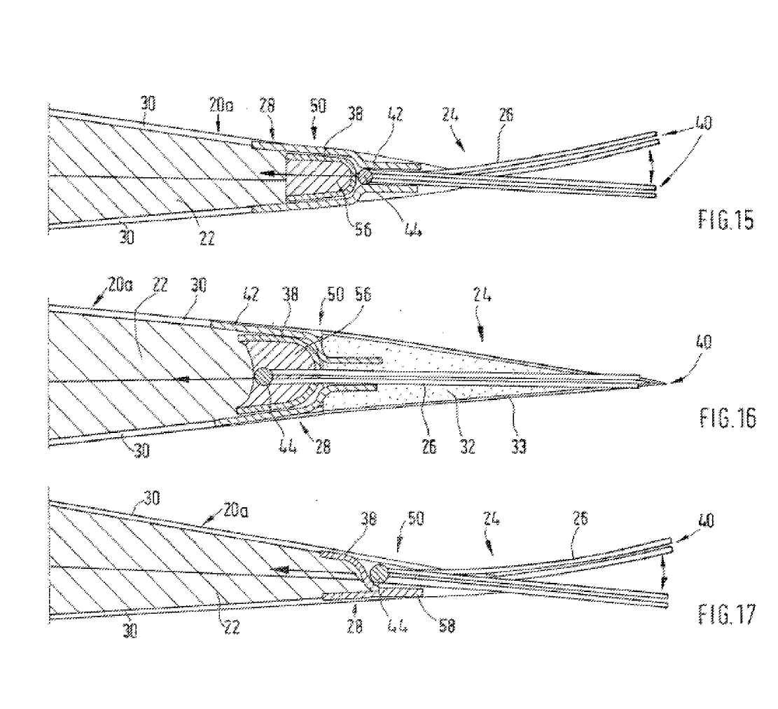

FIG. 15 shows another alternative to the electrical and mechanical interface from FIG. 10;

FIG. 16 shows still another alternative to the electrical and mechanical interface from FIG. 10;

FIG. 17 shows still another alternative to the electrical and mechanical interface from FIG. 10;

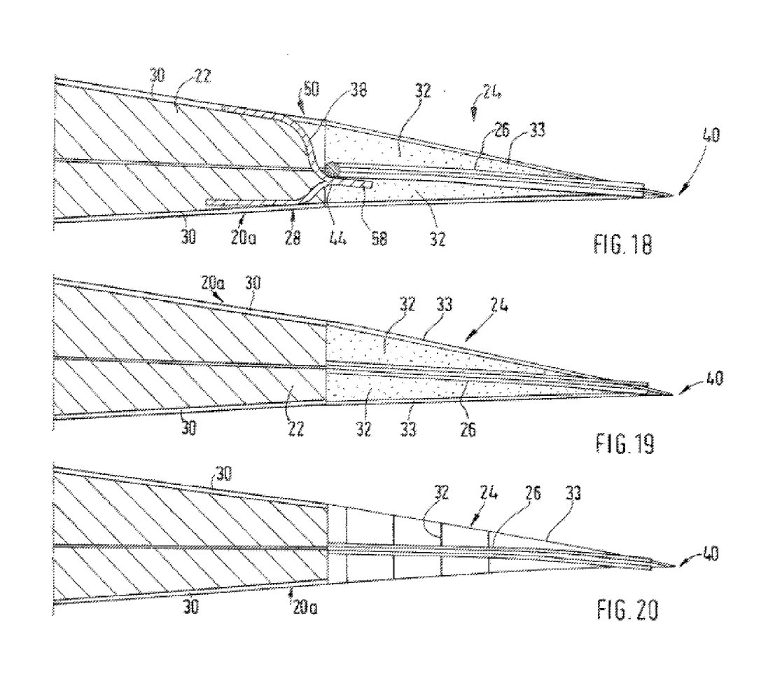

FIG. 18 shows still another alternative to the electrical and mechanical interface from FIG. 10;

FIG. 19 shows a cross-sectional view through a rear edge region of a rotor blade according to the invention, homogeneous filler material being used;

FIG. 20 shows a view according to FIG. 19, nonhomogeneous filler material being used; and

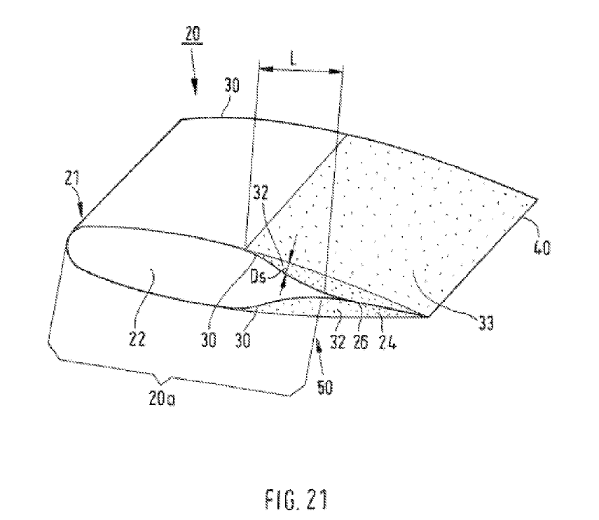

FIG. 21 shows an example of the transition between a profile base body and a rear edge region.

FIGS. 1 and 2 show two embodiments of a rotor blade 20 according to the invention. The rotor blade 20 has a profile base body 20a with a profile core 22 and furthermore has a profile nose region 21 and a rear edge region 23 with a rear edge 40. The profile core 22 extends from the profile nose region 21 to the rear edge region 23. The rotor blade 20 furthermore has a rotor blade flap 24 that is connected to the rear edge region 23 of the profile. The cross-sections shown in FIGS. 1 and 2 through the rotor blade 20 are cross-sections perpendicular to the span direction and in the profile depth direction of the rotor blade 20.

In the embodiment shown in FIG. 1, the rotor blade flap 24 is formed by a reversibly bendable supporting member 26 that is dynamically connected to the actuators and that on its end pointing to the profile nose region 21 has a fastening means 28 with which the supporting member 26 is embedded and attached on a fastening region 50 in the profile core 22 or the profile base body 20a. For reasons of clarity, in FIG. 1, the actuators that are dynamically connected to the reversibly bendable supporting member 26 are not shown. In FIG. 1, the supporting member 26 that forms the rotor blade flap 24 is shown in two different deflection positions. The supporting member 26 is covered on either side with a flexible or elastic protective skin 33. The protective skin 33 can also be provided only on one side. The profile core 22 of the rotor blade 20 is covered by a largely rigid upper and lower cover skin 30 that contributes to stability. The supporting member 26 thus forms an extension of the profile core 22 or of the profile base body 20a in the rear edge region 23 of the rotor blade profile. The profile base body 20a and the rotor blade flap 24 with its supporting member 26 together form the rotor blade profile.

Differently than in the rotor blade profile 20 that is shown in FIG. 1, in the rotor blade profile 20 shown in FIG. 2 not only is the fastening means 28 of the supporting member 26 embedded in the profile core 22 or the attachment region 50 of the profile base body 20a, but a flexurally elastic first filler material 32 is placed between the protective skins 33 in the region of the rotor blade flap 24 and the supporting member 26. Corresponding to FIG. 1, FIG. 2 does not show the actuators that are dynamically connected to the reversibly bendable supporting member 26 either. By the measures shown in FIG. 2, not only is the fastening means 28 that is protected against ambient effects attached in the profile base body 20a, but the entire supporting member 26 is protected. Moreover, the transition between the profile base body 20a and its end region and the rotor blade flap 24 can thus be uniformly deformed without disruptive edges or steps. Due to the elasticity of the first filler material 32 and the protective skin 33, at least in the rear edge region 23 of the rotor blade 20, deflection of the rear edge region 23 of the rotor blade 20 in the manner of a flap can be ensured; however, in addition, the rotor blade flap 24 is reversibly deformed in itself in the shape of an arc.

Especially for comparatively thin rotor blade profiles, this embodiment is preferred since due to a comparatively thin layer of elastic first filler material 32, the transition from the change in motion and deformation of the supporting member 26 to the change of the outer profile contour is not limited. Thus, a change in the shape of the rear edge region 23 of the rotor blade 20 in the desired, flap-like manner, i.e., at least similar to the use of rigid rotor blade flaps, remains ensured. And discontinuities (bends, etc.) in the flap deflection between the profile base body 20a and rotor blade flap 24 are avoided.

As is especially apparent from FIG. 3, the supporting member 26 that forms the rotor blade flap 24, viewed in the span direction (S), has several notches 34. Moreover, FIG. 3 shows by way of example an actuator 35 that is dynamically connected to the supporting member 26. The notches 34 run perpendicular to the span direction (S) here. The rotor blade flap 24 is made as a segmented region by the notches 34. Due to the segmented execution, still part of the elongation from centrifugal force and pivoting on the main rotor blade is transferred into the active rear edge and thus into the actuators 35 that are dynamically connected to the supporting member 26. It follows that the actuators 35 “see” only part of the rear edge elongation and are exposed accordingly to lower stress.

The elongation acting on the actuators 35 can be set via the width of the individual segments, the depth of the notch 34. The effect of the segment width and the effect of the notch depth are shown in FIGS. 4 and 5.

According to the embodiment in FIG. 6, the notches 34 are oriented obliquely to the span direction (S). The oblique execution has the advantage that in using the interrupted, span-wide flow of force in the region of the notches, the loads or stresses are advantageously superimposed by centrifugal force, striking, pivoting, etc., such that in the piezoelement, unwanted stress conditions, especially tension, do not act or unwanted stress conditions are reduced. The actuator elements can be additionally pretensioned in compression in this way. Furthermore, the unfavorable, span-wide bending loads in the actuator and the danger of buckling by centrifugal force are reduced.

FIGS. 7 to 9 schematically show the configuration of the reversibly bendable supporting member 26 and the actuators that are dynamically connected to the supporting member in greater detail in different embodiments. The supporting member 26 consists of fiber composite material or composite material (for example of glass fiber-reinforced plastic). The actuators 35 that are dynamically connected to the supporting member 26 are applied directly to the surface of the supporting member 26. Actuators 35 can be elements that change their shape in a defined manner upon activation or actuation, for example by applying an electrical voltage or else in some other way, for example magnetostrictively. For example, the actuator 35 can contain piezoceramics, for example d33 or d31 piezostacks or piezopolymers that, when exposed to tension, expand or contract in a defined manner in at least one spatial direction, i.e., predictably depending on the magnitude of the activation parameters. The actuators 35 are essentially strip-shaped or plate-shaped, and especially in one spatial direction (the cross-sectional direction shown in FIGS. 7 to 9), they are thin in comparison to the local profile thickness in the rear edge region of the profile.

In the view shown in FIG. 7, in addition to optimization and matching to the bending distribution or the aerodynamic effectiveness of the rotor blade flap 24, the layer thickness (stack thickness) of the piezoelectric element 35 that is applied on both sides to the supporting member 26 of fiber composite material (for example, glass fiber-intensified plastic) is matched. In particular, the supporting member 26 is made with a constant thickness, while the piezoelectric elements 35 have linearly decreasing thicknesses in the direction of the profile depth. The piezoelectric element can also be, for example, a piezostack that is matched in shape and that is worked by cutting.

FIG. 8 shows the reverse case, in which the piezoelements 35 have a constant thickness while the supporting member 26 of glass fiber-reinforced plastic has a variable thickness.

FIG. 9 finally shows a combination in which both the piezoelectric elements 35 and also the supporting member 26 of glass fiber-reinforced plastic are variable in their thicknesses.

FIGS. 10 to 18 show different possibilities for implementing interfaces, i.e., connections between the profile core 22 and the profile base body 20a and the rotor blade flap 24, which connections can be repeatedly detached and restored without major re-adjustment. Here, it is important that forces can be transferred via the interfaces between the upper and lower cover skin 30, i.e., that the torsion box of the front profile region is closed. It is necessary that there be a shear-stiff and flexurally-stiff interface in order to transfer the forces of the flap to the front profile base body 20a, which is made as a torsion box.

It is especially preferred if the interface is made such that the rotor blade flap 24 can be completely separated from the profile base body 20a. For this purpose, the mechanical interface can form a positive or non-positive transition between the separable components or a combination of the two, for example by screws, bolts, rivets or by using tongue and groove profiles.

Examples for increasing the stiffness and for the position of a, for example, electrical interface are likewise shown in the indicated figures. For example, FIG. 10 shows an arrangement in which between the supporting member 26 and the flexible protective skin 33 in the region of the rotor blade flap 24, a flexurally elastic first filler material 32 is placed. A first U-shaped profile 38 that is open to the rear edge 40 of the profile is embedded in the profile core 22, at least in regions. A receiving structure formed by profile elements 42 for the supporting member 26 consists of a double U-shaped channel, the U's of the receiving structure being arranged such that each U encompasses one leg of the first U-shaped profile 38. The supporting member 26 is inserted between the U-shaped profiles 38 of the receiving structure and there in this region also has an electrical interface 44 with reciprocal terminals. The counterpart to the electrical interface with subsequent wiring via the profile core 22 can be provided in or on the profile 38. The U-shaped profiles 38, 42 of the receiving structure are preferably dimensioned such that their legs that are pointed to the upper or the lower “rigid” cover skin 30 of the profile base body reach near to the cover skin 30; this improves transfer of shear forces between the upper and lower cover skin 30. Moreover, the arrangement is preferably chosen such that both part of the U-shaped profile 38 and also part of the profile 42 of the receiving structure are embedded in the profile core 22, while another part extends into the filler material 32 in each case. Thus, even if the structure is made as a rotor blade 20, whose rotor blade flap 24 can be separated from the profile core 22, it can be ensured that the mechanical and electrical interfaces are defined such that even when repeatedly assembled and disassembled, no displacements of the components to one another occur at all and thus the connection can be easily restored.

One alternative for the attachment region 50 is shown in FIG. 11 for the case in which the supporting member 26 without the surrounding first filler material 32 forms the rotor blade flap 24. The supporting member 26 is shown in FIG. 11 in two deflection positions. Differently than in the embodiment shown in FIG. 10, the profile 38 is placed in the profile core 22 or on the rear edge region of the profile base body 20a such that it is arched toward the rear edge 40 of the profile. The receiving structure that is formed by the profiles 42 and that likewise has an essentially U-shaped channel form on the outside encompasses the U of the profile 38 with the same direction of arching. Electrical contact-making means and terminals as the electrical interface 44 can in turn be provided on both the receiving structure and also the profile 38 so that when the receiving structure formed by the profile 42 is separated from the profile 38 and subsequently re-assembled, the interface is defined. The mechanical reinforcement for the interface can be additional positive or non-positive elements. The profile element 42 furthermore pointed toward the rear edge 40 of the rotor blade profile contains a channel-shaped insertion opening 52 through which the supporting member 26 is guided, and into which it is inserted. In this case, the fastening means 28 is embedded completely in the profile core 22 or the back end of the profile base body 20a. Only the supporting member 26 with its actuators that are not shown here extends as the rotor blade flap 24 with one end out of the profile base body 20a beyond the rear edge 40.

FIG. 12 shows the arrangement corresponding to FIG. 11 for the case in which the entire length of the part of the supporting member 26 projecting out of the profile base body 20a is embedded in an elastic first filler material 32. The outside contour of the first filler material 32 forms the outside contour of the rotor blade flap 24 and the outside contour of the rotor blade profile in this region. The attachment structure on the profile base body including the electrical and mechanical interface is the same as in FIG. 11.

The attachment structures according to FIGS. 13 and 14 differ from the attachment structures of FIGS. 11 and 12 in that the supporting member 26 is not inserted into the channel-shaped insertion opening 52 for the supporting member 26, but has a forked end that encompasses the fastening projection 54 on the outside. Only the electrical wiring for the electrical interface 44 is routed through the fastening projection 54. As in FIG. 12, in the variant according to FIG. 14, the supporting member is covered by the first filler material 32 that also extends over the fastening means 50 or its fastening projection 54 and the interface 44.

The attachment structure according to FIGS. 15 and 16 corresponds essentially to the attachment structure according to FIGS. 11 and 12. To increase the stiffness, the U-shaped profile 38 is, however, filled with a second filler material 56 that has higher stiffness than the material of the profile core 22. In the embodiment according to FIG. 16, the second filler material 56 has depressions that arch inwardly in the direction of the rear edge so that a gradual transition from the second filler material 56 to the profile core 22 and the upper and lower cover skin 30 is achieved.

The supporting member 26 can for its part be attached to the receiving structure formed by the profiles 42 in each case by form-fit and/or force-fit.

FIGS. 17 and 18 show other embodiments for the attachment region 50. While in the attachment structures according to FIGS. 10 to 14, in each case essentially symmetrical profile elements 38, 42 were used for essentially symmetrical rotor blade profiles and/or symmetrical flap profiles and flap deflections, whose legs 42 extend in each case to the cover skin 30 in the region of the profile core 22; in the attachment structures according to FIGS. 17 and 18, only one asymmetrical channel formed by a profile 38 is used that has an asymmetrically attached fastening projection 58. On one side, on this projection 58, the supporting member 26 is attached by form-fit and/or force-fit. This configuration is especially suitable for asymmetrical rotor blade profiles and/or asymmetrical flap profiles and flap deflections. This interface structure can also transfer shear forces between the upper and lower cover skin 30 and can ensure a stiff bending interface. The supporting member 26 can be attached to the projection 58 by, for example, cementing, riveting, soldering, screwing or the like.

In the embodiments in which the supporting member 26 is embedded into an elastic first filler material 32 or is coated by it, the first filler material 32, as is shown in FIG. 19, can be made as a homogenous first filler material 32, for example as a foam or an elastomer material or, for example, silicone. The first filler material 32 fills the region between the top and bottom of the supporting member 26 and a flexurally elastic or flexible outer protective layer 33 that at this point forms the outside contour of the flap and of the rotor blade profile. The first filler material 32 and the protective layer 33 follow the reversible bending of the supporting member 26 that results in an arc-shaped, continuous rotor blade flap deflection.

Alternatively thereto, for the first filler material 32, nonhomogeneous material or a structure as is shown in FIG. 20 can also be used. This structure is, for example, a type of supporting framework, for example of rib-like stiffening elements extending in the direction of the profile thickness, which likewise has sufficient elasticity and flexibility to follow the motion of the supporting member 26. Here, for the first filler material 32 in the same manner as for the protective skin 33, some directional dependency of the filler material and the protective skin can be used.

In the embodiments explained above, the transition between the rotor blade flap 24 and the profile core 22 or the profile base body 20a and the first filler material 32 has always been described as a relatively abrupt, straight transition. Of course, however, the transition can also take place gradually. As shown in FIG. 21, it is possible, for example, for the profile base body 20a to taper with the attachment region 50 toward the rear edge 40. And the first filler material 32 that is provided on the top and bottom of the supporting member 26 extends in this embodiment beyond the attachment region 50 as far as the profile base body 20 and its upper and lower cover skin 30. The transition length L that is measured in the direction of profile depth and in which the first filler material 32 extends over the profile base body 20a can be fixed depending on the predetermined rotor blade profile and the required profile-geometrical properties of the rotor blade flap 24 in the neutral state and in the deflected state. It furthermore follows from FIG. 21 that the local layer thickness D_{S} of the first filler material 32 proceeding from the rear edge 40 to the attachment region 50 first increases and then decreases again in the direction to the profile nose region 21.

The invention is not limited to the aforementioned embodiments. Within the framework of the scope of protection, the rotor blade according to the invention can rather also assume embodiments other than those described specifically above. Thus, for example, it is possible for the part of the rotor blade profile containing the supporting member 26 and the rotor blade flap 24, including that part of the profile base body 20a that has the attachment region 50, to also be made as a separate flap module that can be detachably fastened to the remaining part of the profile base body 20a.

### REFERENCE NUMBER LIST

20 Rotor blade
20a Profile base body
21 Profile nose region
22 Profile core
23 Rear edge region
24 Rotor blade flap
26 Reversibly bendable supporting member
28 Fastening means
30 Cover skin
32 Flexurally elastic filler material
33 Flexurally elastic protective skin
34 Notches
36 Actuator
38 U-Shaped profile
40 Rear edge of profile
42 Profile element
44 Electrical interface and/or terminals
50 Attachment region
52 Insertion opening
54 Fastening projection
56 Filler material
58 Fastening projection
D_{S} Local layer thickness of the first filler material 32
L Transition length
S Span direction
A Direction of lift

1. Rotor blade (20), especially for a rotary wing aircraft, comprising the following:
an aerodynamically effective rotor blade profile with a profile nose region (21), a
profile base body (20a) with a profile core, an upper and lower cover skin (30) that envelops the profile core (22), and a profile rear edge region (23) with a rear edge (40),
a reversibly bendable supporting member (26) that can be attached with the first
end to the end region of the profile base body (20a) pointing toward the rear edge (40) and projects with the second end freely out of the profile base body (20a) and its end region toward the rear edge (40) and forms a movable rotor blade flap (24),
actuators (35) that are dynamically connected to the projecting second end of the
reversibly bendable supporting member (26) and an arc-shaped flap deflection can
be initiated via the change in length of the actuators, the second end of the reversibly
bendable supporting member (26) that forms the rotor blade flap (24) viewed in the
direction of the span (S) being divided by notches (34) into several segments to
which at least one actuator (35) at a time is assigned.

2. Rotor blade according to claim 1, wherein the notches (34) are arranged perpendicular to the span direction (S).

3. Rotor blade according to claim 1, wherein the notches (34) are arranged obliquely to the span direction (S).

4. Rotor blade according to claim 1, wherein the actuators (35) are applied directly to the reversibly bendable supporting member (26).

5. Rotor blade according to claim 1, wherein the actuators (35) are made as piezoactuators.

6. Rotor blade according to claim 5, wherein the piezoactuators (35) and/or the reversibly bendable supporting member (26) have a varying thickness.

7. Rotor blade according to claim 1, wherein the reversibly bendable supporting member (26) is made from a fiber composite material, especially from a glass fiber-reinforced plastic material.

8. Rotor blade according to claim 1, wherein there is an actuator (35) on both sides of the segments, viewed in the direction of lift (A).

9. Rotor blade according to claim 1, wherein there is an actuator (35) only on one side of the segments, viewed in the direction of lift (A).

10. Rotor blade according to claim 1, wherein the supporting member (26) is made as a resetting means for the actuators (35).

11. Rotor blade according to claim 1, wherein at least the second end of the reversibly bendable supporting member (26) that forms the movable rotor blade flap (24) is coated with a flexible, flexurally elastic first filler material (32) that in this region of the rotor blade profile forms its outside contour.

12. Rotor blade according to claim 11, wherein the flexible, flexurally elastic first filler material (32) extends as far as the profile base body (20a) or on or under its cover skin (30).

13. Rotor blade according to claim 11, wherein the flexible, flexurally elastic filler material (32) is a homogeneous flexible, flexurally elastic filler material (32), especially an elastomer material, especially a silicone material or a foam material.

14. Rotor blade according to claim 11, wherein the flexible, flexurally elastic filler material (32) is a nonhomogeneous flexible, flexurally elastic filler material (32), especially a material with rib-like or supporting framework-like or skeleton-like stiffening elements.

15. Rotor blade according to claim 11, wherein the flexible, flexurally elastic first filler material (32) is a flexible, flexurally elastic protective skin (33) that forms the outside contour of the rotor blade profile at least in the region of the rotor blade flap (24).

16. Rotor blade according to claim 15, wherein the flexible, flexurally elastic protective skin (33) is an integral component of the flexible, flexurally elastic first filler material (32).

17. Rotor blade according to claim 15, wherein the flexible, flexurally elastic protective skin (33) is a separate protective layer that has been applied to the flexible, flexurally elastic first filler material (32).

18. Rotor blade according to claim 1, wherein the upper and lower cover skin (30) extends as far as the first end of the supporting member (26) and holds the supporting member (26), and the second end of the supporting member (26) projects freely between the upper and lower cover skin (30).

19. Rotor blade according to claim 1, wherein the cover skin (30) extends as far as the supporting member (26) and in this section has a skin thickness that has been reduced relative to those regions of the cover skin (30) that envelop the profile base body (20a) with its profile core (22) so that the cover skin (30) in this section can be deformed together with the supporting member (26) to an arc-shaped rotor blade flap deflection.

20. Rotor blade according to claim 1, wherein the cover skin (30) extends as far as the supporting member (26) and in the region of the first end of the supporting member (26) has a local discontinuity in its flexural stiffness that forms a virtual rotor blade flap joint via which the supporting member (26) can be deformed into a rotor blade flap deflection.

21. Rotor blade according to claim 1, wherein on or in that end region of the profile base body (20a) that is assigned to the supporting member (26), there is a fastening device (28) to which the supporting member (26) or the rear edge region (23) of the profile that has the rotor blade flap (24) with a supporting member (26) can be detachably fastened.

22. Rotary wing aircraft, especially a helicopter, with at least one rotor with at least one rotor blade (20) according to claim 1.
